(19) United States
(12) Patent Application Publication
(10) Pub. No.: US 2023/0152074 A1
(43) Pub. Date: May 18, 2023

(54) REPEATED DETERMINATION OF A POSITION OF A MOVABLE PART OF A COORDINATE MEASURING MACHINE

(71) Applicant: Carl Zeiss Industrielle Messtechnik GmbH, Oberkochen (DE)

(72) Inventors: Udo Gruber, Pappenheim (DE); Guenter Grupp, Boehmenkirch (DE)

(21) Appl. No.: 17/987,784

(22) Filed: Nov. 15, 2022

(30) Foreign Application Priority Data
Nov. 15, 2021 (DE) 10 2021 212 817.3

(51) Int. Cl. G01B 5/008; G01P 15/18

(52) U.S. Cl. CPC G01B 5/008; G01P 15/18

(57) ABSTRACT

A position of a movable part of a coordinate measuring machine (CMM) is determined repeatedly. A position value of the part is measured at a reference location. First and second acceleration values are measured at a first and second measuring location. The second measuring location is closer to a measuring sensor than the first measuring location and the first measuring location is closer to the reference location than the second measuring location. A target and/or actual state value is supplied to a model of the CMM. Estimators are modelled. The model is supplied with a position deviation based on the estimator of the position deviation and deviation based on the estimator of the deviation and the deviation of the measured first and second values. The position of the part is determined from the measured position value in relation to the reference location based on the estimator of the position deviation.

### CROSS REFERENCE TO RELATED APPLICATIONS

This application claims priority to German Patent Application DE 10 2021 212 817.3, filed Nov. 15, 2021, the entire content of which is incorporated herein by reference.

### TECHNICAL FIELD

The disclosure relates to a method for repeated determination of a position of a movable part of a coordinate measuring machine and further relates to an arrangement having a coordinate measuring machine and having a position determining device.

### BACKGROUND

Coordinates of workpieces in a coordinate system can be determined using coordinate measuring machines. The mechanical and kinematic structure of coordinate measuring machines (abbreviated CMM below) may differ. By way of example, this may relate to a gantry-type, articulated arm-type, parallel kinematic-type or horizontal arm-type CMM. Robots, for example articulated-arm robots, may also be used as coordinate measuring machines, especially if they carry a measuring sensor. In all cases, the CMM has a movable part, on which a measuring sensor is fastened and/or coupled either directly or indirectly. Therefore, the measuring sensor is also moved by moving the movable part, in particular in order to bring said measuring sensor into a position and/or alignment in which a workpiece is measured. The movement of the movable part is driven by at least one drive of the machine.

Coordinates of the measurement object are determined during the measurement, for example while the measuring sensor is at rest or not in motion relative to the workpiece. Optionally, a measuring sensor may for example sense the measurement object (the workpiece) in a scanning fashion during the movement, for example a tactile or an optical measuring sensor.

By way of example, the sensor is a measuring head mounted on a movable part (for example a quill or an arm) of the CMM. On the measuring head it is possible to mount a probe (e.g., a stylus), in particular, using which the CMM probes the surface of the workpiece in a tactile manner. Therefore, in particular, a probe for the tactile probing of the workpiece to be measured is also an example of a sensor or of a part of the sensor. In any case, the measuring head may include a sensor system, in particular, which produces measurement signals whose evaluation or processing allows the coordinates to be determined.

However, other measuring sensors also crop up in coordinate measuring technology. By way of example, the sensor may merely initiate the measurement of the coordinates. This is the case for example for a switching measuring head which produces a switching signal upon contact with the workpiece to be measured, which switching signal initiates the measurement of the coordinates, e.g., by reading of the scale or the scales of the position measuring system at the movable part or the movable parts of the CMM. In principle, the sensors can be classified into sensors that carry out measurement by contact (tactile probing of the workpiece) and sensors that carry out measurement without contact. By way of example, optical sensors (e.g., cameras, chromatic-confocal sensors or lasers) or capacitive sensors for coordinate measurement are sensors which are not based on the principle of tactile sensing. Moreover, it is possible to classify sensors according to the type or size of the in particular simultaneously detected region of the workpiece. In particular, sensors may measure coordinates just of a point or of an area on the surface or else in the interior of the workpiece or measure coordinates of a volume of the workpiece.

In particular, the measuring sensor can be securely connected to the movable part or to at least one of the movable parts of the CMM, the position of which during the operation of the CMM is measured by a position measuring system of the CMM. A secure connection should also be understood to mean a connection that is detachable again, said connection for example being establishable by, or consisting of, an interchange interface. As an alternative or in addition to a secure connection, there may be a movable connection, or said movable connection may be established, between the measuring sensor and at least one of the movable parts of the CMM. By way of example, the measuring sensor may be connected via at least one rotary joint with one axis of rotation or with a plurality of axes of rotation to one of the movable parts.

By way of example, this movable part of the CMM may be the quill of a gantry-type coordinate measuring machine, or the horizontal arm of a horizontal arm-type machine. At least one interchange interface may also be used in the case of the movable connection. The respective interchange interface permits coupling and decoupling of the tool and/or of the rotary joint.

In particular, the movable part may be an elongate part, e.g., an arm, the length of the elongate part being a multiple (e.g., at least five times or at least 10 times) of the width and depth of the elongate part. The width and depth may be measured in two mutually perpendicular directions that are perpendicular to the longitudinal direction.

Mechanical vibrations which, in particular, are excited by the at least one drive of the machine may occur on the moveable part and hence on the measuring sensor in the case of the CMM of the aforementioned type having at least one movable part and a measuring sensor that is directly or indirectly connected or coupled to the movable part. Such vibrations, and possibly vibrations that have a different origin, are transferred via the movable part to the sensor which is indirectly or directly connected and/or coupled to the movable part. Although the position measuring system of the CMM measures the current position of the movable part, it does not, in almost all movement positions, measure the position of the region of the movable part that is connected or coupled to the measuring sensor. In almost all movement positions, the point at which the position measuring system measures the position of the movable part lies at a significant distance or even at a far distance from the region to which the tool is coupled or connected. Depending on the structure and/or the mode of operation of the CMM, the region may additionally never come into the vicinity of this point. Therefore, the position measuring system is unable to directly measure the unintended changes in the position of the region on account of vibrations.

On the other hand, the position of the region of the movable part to which the measuring sensor is coupled and/or to which it is fastened is required for determining the position of the measuring sensor and hence also for determining the coordinates of the measurement object that is measured with the aid of the measuring sensor. The coordinates should not be determined or not only be determined in the coordinate system of the measuring sensor but, in particular, should be determined in the coordinate system of the measurement object or a base of the coordinate measuring machine.

By way of example, in the case of a gantry-type (i.e., a bridge-type) coordinate measuring machine, vibrations may occur at the lower end of the quill to which the measuring head is coupled, in the direction (denoted Y-direction as a rule) in which the entire bridge or the entire gantry is displaceable. In the case of a coordinate measuring machine with a horizontal arm design, significant vibrations may occur in the direction (denoted X-direction as a rule) in which the horizontal arm is movable together with the stand that is displaceable relative to the base, in particular in the case of a greatly extended horizontal arm to which the measuring sensor is attached.

It is possible to provide, for example at the lower end of the quill or at the end of the horizontal arm, an acceleration sensor which measures the accelerations on account of vibrations in the region to which the measuring sensor is coupled or to which it is connected. The time-dependent measurement values from the acceleration sensor can be integrated twice over time such that the position is obtained as a function of the location. However, this assumes that the initial value for integrating twice is known and the acceleration sensor and also the two-fold integration over time do not produce a significant error that falsifies the result. Trials by the inventors have shown that, in any case, acceleration sensors which can be mounted on a CMM for permanent operation at justifiable costs do not supply sufficiently accurate determination results for the position over typical operation times of coordinate measuring machines if the effects of mechanical vibrations should also be taken into account. Instead, it was found that, over time, the phase and amplitude of the determination result increasingly deviate from the actual phase and amplitude of the vibration.

US 2014/0222373 A1 describes a method for providing dynamic state information for a coordinate measuring machine including a drive mechanism that moves a sensor head relative to a base of the coordinate measuring machine. A dynamic model is defined, including current state variables in relation to physical properties that represent a current state of the coordinate measuring machine. The current state is derived by calculation on the basis of the dynamic model. Prediction variables are derived on the basis of the state variables. The prediction variables describe an expected approximate state of the coordinate measuring machine. At least one of the state variables is measured. Observables are determined and subsequent state variables are derived by a comparison between the predicted variables and the observables, and the dynamic model is updated using the subsequent state variables as current state variables. The set of state variables used in the dynamic model represents a set of specific physical parameters of a part of the coordinate measuring machine. The state variables and/or the physical properties to which these correspond are measured in order to determine a deviation of at least one of the variables. The acceleration and the position, inter alia, are mentioned in respect of possible input values for the model in relation to the measurement of the state variables and/or prediction variables. In contrast to the input values, the mass, the inertia, geometric properties, stiffness, damping, mounted properties, torque, temperature, humidity, speed and/or forces exerted are mentioned as examples of state variables and of the prediction variables and the observables.

WO 2016/151101 A2 describes a method for creating or refining a mathematical correction model for correcting measurement errors in a coordinate measuring machine having at least three linear machine axes that each include a linear scale. The coordinate measuring machine is provided with a measuring probe. The method includes accelerating the measuring probe and at least one of the three linear machine axes of the coordinate measuring machine along one of the linear machine axes and creating or refining the mathematical correction model using an apparent measuring probe position, an actual measuring probe position and an acceleration of the coordinate measuring machine at the apparent position and at the actual position. The mathematical correction model includes a correction term for an offset for one or more of the linear scales of the machine, with this offset being defined as the distance between the measuring probe and the respective machine scale.

DE 10 2016 220 097 A1 describes a method for determining a position of a movable part of a coordinate measuring machine, wherein a measuring sensor of the CMM is moved by way of a movement of the movable part. Target values produced by a drive controller of the coordinate measuring machine are supplied to a computational model of the CMM. The target values specify a target state of at least one drive of the CMM. Position deviations between measured position values and position estimators of the computational model are determined. Further, acceleration values are measured, wherein the acceleration sensor is arranged at an acceleration measuring location, which is a location at or in the movable part, and wherein the acceleration measuring location is at a distance from a position measuring location of the position measuring system in all or most possible movement positions of the movable part and, in all or most possible movement positions of the movable part, lies closer to the predetermined location than the position measuring location of the position measuring system at which the position measuring system measures the position values of the movable part. Moreover, acceleration deviations between the measured acceleration values and acceleration estimators of the computational model are formed. The position deviations and the acceleration deviations are supplied to the computational model, and, taking these into account, the computational model outputs updated position estimators and updated acceleration estimators.

### SUMMARY

It is an object of the present disclosure to provide a method for repeated determination of a position of a movable part of a coordinate measuring machine and an arrangement having a coordinate measuring machine and having a position determining device, which allow the determination of the position of the movable part even if mechanical vibrations occur on the movable part. In particular, the vibrations can be vibrations excited by a drive of the CMM and/or vibrations on a base (for example, a floor below the CMM or a baseplate, for instance a granite plate) of the CMM and/or vibrations on account of an optionally present air bearing of the CMM.

In accordance with an aspect of the present disclosure, position measurement values of the movable part are measured by the position measuring system of the coordinate measuring machine. Here, the position of the movable part can be measured by the position measuring system at the movable part itself or at another movable part which, in respect of the position or position component (e.g., the position component in the Y-direction) to be measured, is moved in the same way as the movable part. By way of example, the Y-position of the movable part (e.g., of the quill of a CMM with the bridge design) can be measured at at least one of the columns of the bridge and hence also reproduces the Y-position of the quill. However, these position measurement values contain small deviations of the position of the quill from the position of the columns of the bridge on account of vibrations and bending of the quill.

The position measuring system measures the position value in relation to a reference location of the coordinate measuring machine, which reference location can move in the case of a movement of the movable part. The reference location is the location of the coordinate measuring machine whose position is measured in order thereby to obtain information about the position of the movable part. Further, the reference location may move in the case of movement of the movable part. However, depending on the pose of the reference location and depending on the structure of the CMM, the reference location does not move with every movement of the movable part. An example for the position being measured at a different movable part of the CMM was already described above, i.e., the reference location is on, e.g., the other movable part in that case.

By way of example, in the case where a scale that is part of the position measuring system is present on the CMM, the reference location is movable relative to the scale and its position is determined using the scale. However, conventional scales only allow the position to be determined in relation to one degree of freedom of movement or in relation to some of the available degrees of freedom of movement. In the case of a linear scale, the position is determined in relation to a single linear degree of freedom of movement. Moreover, there are, for example, scales that allow a determination in relation to a rotational degree of freedom of movement. In particular, it is therefore also possible to determine the alignment of the movable part.

However, the position measuring system may also be configured such that it can measure the position at least in respect of one degree of freedom of movement without the use of a scale arranged on the CMM, or can measure this position in another way in addition to the scale. In particular, the position measuring system may include a detection device. Should the reference location move relative to the detection device, the detection device detects the movement, that is to say the change in position, and/or the altered position of the reference location. By way of example, optical detection devices such as cameras with camera image evaluation, laser tracers and laser translation systems come into question.

As is the case, in particular, in the above-described exemplary embodiment of a coordinate measuring machine with a gantry or bridge design, a respective reference location, in relation to which the position of the movable part is determined, may be present for different components of the position (e.g., X-component and Y-component). Conversely, it follows that the determination of the position in relation to the reference location may also relate merely to a component of the position. Therefore, the scope of the disclosure also includes a method or a coordinate measuring machine with a determination of the position in relation to merely one position component, that is to say in relation to a single linear degree of freedom of movement. Additionally, the position may be determined from a known, earlier position and the movement of the reference location, for example in accordance with the principle of movement tracking.

Further, a first acceleration value is measured at a first acceleration measuring location of the coordinate measuring machine with a first acceleration sensor and a second acceleration value is measured at a second acceleration measuring location of the movable part with a second acceleration sensor.

The first acceleration measuring location is located on the coordinate measuring machine and consequently not in the surroundings of the coordinate measuring machine such as the floor. One option consists of both the first acceleration measuring location and the second acceleration measuring location being located on the movable part. However, in each case the second acceleration measuring location is arranged closer to the measuring sensor than the first acceleration measuring location or the second acceleration measuring location is a location of the measuring sensor. Further, the first acceleration measuring location is arranged closer to the reference location than the second acceleration measuring location or the first acceleration measuring location is the reference location. The second acceleration measuring location is not the reference location in any case.

As described above, the respective acceleration measuring location is the location at which the respective acceleration value is measured. The associated acceleration sensor is typically located at the acceleration measuring location. By way of example, micro-sensors, in particular micro-electromechanical systems (MEMS), are suitable acceleration sensors for measuring accelerations, that is to say the second derivative of position with respect to time. By way of example, the acceleration sensors can be sensors that operate according to the measurement principle of a piezoelectric sensor. If forces act on the crystal of the sensor, a corresponding separation of charge of positively charged and negatively charged particles is effectuated, said separation being able to be measured as voltage, for example. However, the crystal or, in the case of a plurality of crystals, the crystals does not or do not have a constant voltage in the case of a constant acceleration since the charge separation is increasingly reverted over time. However, other acceleration sensors also produce acceleration measurement values that are afflicted by errors. Further, a MEMS sensor that measures capacitively, for example, may be used as an acceleration sensor. Processing the measurement values of such sensors is afflicted by errors because, in particular, interferences occur on account of external influences, said interferences leading to changes in the measurement signal or errors during the transmission of the measurement signal. Nevertheless, capacitively measuring MEMS sensors are preferred for the purposes of the present disclosure. In particular, acceleration sensors including a body with a mass that is displaceable counter to a spring force are also known. In particular, such sensors measure not only accelerations that occur in the case of mechanical vibrations of the measuring location but also accelerations that are constant over time, for example like those caused by the Earth’s gravitational field. Nevertheless, (like other sensors whose measurements are afflicted by error) they come into question for the exemplary embodiment of the present disclosure since two acceleration sensors are present or used by way of the first acceleration sensor and the second acceleration sensor, and the difference of the acceleration measuring values is formed therefor (see below). When the difference is formed, constant accelerations co-measured by both acceleration sensors and other errors occurring in the same way in both sensors are cancelled.

It is therefore typical for the first and the second acceleration sensor to have the same design and typically be of the same type because, as mentioned above, design-dependent measurement errors and other influences are cancelled when the difference is formed, that is to say these no longer occur in the difference. The difference therefore reproduces the value of interest, specifically the difference in the second time derivatives of the position with respect to time, at the acceleration measuring locations. In particular, the acceleration may however also be determined indirectly, for example by measuring the position as a function of time and forming the second time derivative. By way of example, the aforementioned laser triangulation sensors and laser tracers come into question for the precise measurement of in each case the position at the measuring locations of the acceleration. Acceleration sensors of the same design are typically used in this case too, and the acceleration at both measuring locations is for example determined in the same way from the position measurement value as a function of time.

In the exemplary embodiment of the bridge-type CMM, the second acceleration sensor is located at the lower end of the quill, for example. In the case of a horizontal arm measuring machine, the second acceleration sensor is located, for example, at the end of the horizontal arm to which the measuring sensor is also coupled or to which the measuring sensor is connected.

In particular, the first acceleration measuring location generally is located close to the reference location or is the reference location. Since, in any case, the second acceleration measuring location is closer to the measuring sensor or is a location of the measuring sensor, it is possible to detect differences between mechanical vibrations firstly carried out by the measuring sensor and secondly occurring at the reference location, in full or in part, by way of the difference between the acceleration measurement values. This enables a reliable correction of the effects of mechanical vibrations on the measuring sensor, taking account of the fact that the position measuring system of the CMM measures the position of the measuring sensor not directly at the measuring sensor but at the reference location.

Since the compensation or consideration of mechanical vibrations is the focus here, and since these are not significantly transferred via the air and interstices, “closer” does not necessarily relate to the shortest straight-line direction. Instead, “closer” relates to the shorter connection via solid materials. Therefore, the shortest connection may run “around the corner”, especially in the case of angled structures.

It has already been mentioned that the position measurement at the reference location or at the reference locations can be carried out component-by-component. In particular, the determination of a position of the movable part using a computational model, as described below, may likewise be carried out component-by-component, or a position determining device may be configured in this way. The corresponding component of the difference of the acceleration measurement values is taken into account in this case for each component of the position (this may also be merely a single component) which is corrected in relation to mechanical vibrations according to the disclosure. Therefore, if the X-component, for example, of the position of the movable part is determined, the difference of the X-components of the acceleration measurement values at the first and second acceleration measuring location is used for the vibration correction. It may but need not be the case that all three components of the position are corrected in this way, and, for example, the influence of mechanical vibrations in the Z-direction (direction of the longitudinal axis of the quill) is low in the case of a coordinate measuring machine with a gantry or bridge design. As mentioned above, each of the three components corresponds to one of three linearly independent degrees of freedom of movement and so these components can be defined in relation to a Cartesian coordinate system, for example.

Further, a state value, which describes a target state and/or an actual state of the coordinate measuring machine, is supplied to a computational model (e.g., implemented by computer in a controller of the CMM) of the coordinate measuring machine. In particular, the target and/or actual state is a kinematic state of the CMM, for example a position, a speed, an acceleration, or a state of a drive device of the CMM. The drive device, which causes a movement of the movable part when in operation, has a direct influence on the kinematic state, and so its state corresponds to the kinematic state. By way of example, the manipulated variable supplied to a drive motor of the drive device (for example the value of an electric current) leads to a corresponding rotational speed of the drive motor, and this in turn leads to a corresponding speed of the movable part that is driven by the drive motor.

By way of example, values of the target rotational speed, of the target speed or of the target electric current of at least one drive motor are supplied to the computational model. The target values are the target values for operating at least one drive motor, with which the movement of the movable part is driven indirectly via at least one further movable part or directly. If only one position component is measured, it is possible, for example, to supply only the target value relating to the direction of the component to the computational model, for example the target current or the target rotational speed of the drive motor or the drive motors which effectuate the movement of the movable part in this direction. The drive controller or drive regulator can be operated with the target values which are also supplied to the computational model. This may mean that the target values are supplied to a further part of the drive controller or drive regulator (e.g., the target rotational speed as an output signal of a position regulator is supplied to a rotational speed regulator or the target current value as an output signal of a rotational speed regulator is supplied to a current regulator) and/or that the at least one drive motor is actuated in accordance with the respectively valid target value. By way of example, an electric current that corresponds to the target electric current is set. Here, like in any controlled or regulated system, there may be deviations between the current actual value and the current target value. On the other hand, these target values of the drive device of the CMM may also be interpreted as actual values of the drive controller (for example of a rotational speed regulator). Accordingly, these are both target values and actual values.

In general, the state value supplied to the computational model may describe a target state and/or an actual state, as mentioned above. In most cases, the state value describes either a target state or an actual state. For many configurations of the disclosure, it is sufficient if the computational model is repeatedly supplied with current values of merely a single state variable, this in particular relating to a state variable of either a target state or an actual state. In all cases, the state values serve to allow the computational model to model the CMM appropriately and realistically.

The computational model is a model of the CMM or of a part of the CMM. By way of example, this may relate to a part of the CMM which extends from the reference location to the measuring sensor. As also explained above in relation to the closeness of the acceleration measuring locations, “extends” relates to the mechanical coupling or linking of the reference location to the movable part or within the movable part up to the measuring sensor. In particular, when considered from a control theory point of view, the computational model is a model of the controlled system for closed-loop control of the drive device, the operation of which drives the movable part of the CMM and consequently moves the latter.

The computational model is configured to form an estimator of a position deviation between the reference location and the second acceleration measuring location and typically to output the position deviation (i.e., its value) from the computational model. This position deviation can be defined such that it equals zero in the ideal case where no mechanical vibrations are present. In this case, the value zero is the expected value or the long-term mean. However, in actual fact, the positions of the reference location and of the second acceleration measuring location differ, for example in the coordinate system of the CMM, to be precise by a value that is constant over time in the case where no mechanical vibrations are present. Therefore, the estimated deviation from the expected value currently formed by the computational model may be output as the estimator of the position deviation, with the expected value typically being zero but possibly also being chosen to be different. Instead of a position deviation with the physical dimension of a length, it is also possible to output a corresponding variable, for example a speed deviation, which accordingly has the physical dimension of a length divided by time, or an acceleration deviation, which accordingly has the physical dimension of a length divided by time raised to the power of two. From this, the position deviation can be determined again by integrating over time once or twice. Therefore, such a deviation also includes the information about the position deviation. In practice, the output of a numerical value is sufficient if the physical dimension is known during the further processing. All these deviations are based on an estimator at the second acceleration measuring location.

The estimator of the position deviation formed allows the measured position of the movable part to be corrected in relation to the reference location as it is the result of modelling the CMM. This also applies when the expected value is zero. In this case, the time-constant difference in the positions of the reference location and the second acceleration measuring location are taken into account during the correction or in advance. As will be explained in more detail below, modelling includes taking account of the mechanical vibrations at the acceleration measuring locations. The position of the movable part can be corrected immediately by using the estimator (especially of the position deviation) output by the computational model. However, it is also conceivable to use not the estimator directly output by the computational model but a corresponding variable instead. By way of example, the deviation of the speeds or the accelerations at the acceleration measuring locations may also be output for correcting the measured position of the movable part, and the position deviation can be determined by integration over time.

Furthermore, the computational model is configured to form an estimator of an acceleration deviation between the acceleration at the first acceleration measuring location and the acceleration at the second acceleration measuring location and to output the acceleration deviation (i.e., its estimator) from the computational model.

The output estimator of the acceleration deviation allows a comparison with the actually measured acceleration values.

In order to design the computational model to be firstly robust and secondly accurate in relation to the consideration of the mechanical vibrations between reference location and measuring sensor, two further variables are supplied to the computational model in addition to the aforementioned state variable: a position deviation and an acceleration deviation (i.e., their values).

Therefore, a position deviation is supplied to the computational model taking into account the estimator of the position deviation between the reference location and the second acceleration measuring location. The estimator of the position deviation previously formed by the computational model therefore also determines the position deviation supplied to the computational model (or determines it completely), which is why the position deviation can be referred to as having been fed back.

Further, an acceleration deviation is supplied to the computational model taking into account the estimator of the acceleration deviation between the acceleration at the first acceleration measuring location and the acceleration at the second acceleration measuring location and taking into account a deviation (the aforementioned difference) between the measured first acceleration value and the measured second acceleration value. The estimator of the acceleration deviation previously output by the computational model therefore also determines the acceleration deviation supplied to the computational model, which is why the acceleration deviation can be referred to as having been fed back. However, in this case both the estimator of the deviation previously output by the computational model and the difference between the measured acceleration values are taken into account. In particular, the difference of these differences is formed and fed back, or supplied to the model.

If information such as the respective deviation or else a target value or actual value is supplied to the computational model, then, depending on the type of information, this may also be an internal supply within the computational model. By way of example, the supplied information may be based in full or in part on information produced by the computational model itself. This will be discussed in more detail below. Ultimately, the answer to the question whether information is supplied to the computational model from externally or from internally also depends on where the boundaries, and hence the interfaces, of the computational model are drawn. Depending on the definition of the boundaries of the computational model, a weighting of information supplied to the computational model may occur within or outside of the computational model. If the information is supplied to the computational model from within the computational model and if this information or the variable is weighted, then the weighting is also implemented internally. Internal supply of the information occurs in such a way, in particular, that the information obtained during a calculation cycle of the computational model is available to the computational model for the next or a subsequent calculation cycle.

The same applies correspondingly to information output from the computational model. In particular, this relates to the estimator of the position deviation between the reference location and the second acceleration measuring location. Even though preferred, it is not necessary for the estimator output by the computational model to be used directly for the determination of the position of the movable part. Nevertheless, this estimator can be output at least internally, in particular as a result of carrying out a calculation cycle of the computational model.

The position deviation supplied to the computational model and the acceleration deviation supplied to the computational model may be processed in particular. In particular, they are weighted in the process, as a result of which it is possible to set the influence of the deviations on the modelling of the CMM that is implemented by the computational model. The influences of the position deviation and the acceleration deviation thus can be compared to one another after their processing, in particular after their weighting, as they then no longer relate to different physical variables. Depending on the definition of the boundaries of the computational model, the processing may be considered to be an action of the computational model or to be pre-processing. The output of the estimators may also be an internal output from a part of the computational model, or an output from the computational model to external entities. However, within the scope of the feedback of the acceleration deviation, an additional external variable, specifically the difference between measured acceleration values, is taken into account in any case. More details will be provided below in relation to the fact that an additional external variable need not necessarily be taken into account within the scope of the feedback of the position deviation. Rather, this is typically not the case.

In particular, the computational model can be a physical model, a mathematical model and/or a numerical model (e.g., a finite element-based model) of the CMM. In the case of a physical model, the variables processed by the computational model (and not only the input and output variables) at least partly have physical meanings such as speed, position and acceleration or control voltage of the drive motor.

If the description makes use of the plural for the measurement values, estimators and deviations, this means that measurement values are repeatedly measured, estimators are repeatedly produced and output by the computational model and deviations between at least one measurement value and at least one estimator are repeatedly formed. In particular, a position deviation can be formed in each case at a current instant of the operation of the CMM and said position deviation can be fed back to the computational model. The same applies correspondingly to the acceleration deviation. However, determining a plurality of deviations or a deviation taking into account a plurality of measurement values and/or a plurality of estimators at a current instant is not precluded either.

In particular, the operation of the CMM using the computational model can be performed in the case of a repeated execution of the operations of the computational model in successive work cycles.

The aforementioned procedures using computational models are known, in principle, from control engineering in respect of the repeated execution of operations of the computational model, in respect of the repeated supply of input variables to the computational model and in respect of the repeated output and processing of the output variables of the computational model. Therefore, the basics of control engineering, in particular in relation to so-called observers and so-called Kalman filters, are not repeated here. As a matter of principle, they are also known to a person skilled in the art in the field of coordinate metrology. By way of example, US 2016/0178362 A1 describes the compensation of the mechanical effects of vibrations of a sensor element of a coordinate measuring machine using an observer or Kalman filter, wherein, however, the sensor element therein is combined with an actuator for producing a measurement force that should be exerted by the sensor element and the actuator is actuated for damping or compensating mechanical vibrations. Vibration-related differences between the positions at a position measuring location (reference location) and at a second acceleration measuring location closer to the measuring sensor are not considered therein and there is also no feedback of the acceleration deviations and position deviations to the computational model.

As already mentioned above, the position of the movable part is determined from the measured position value in relation to the reference location and in accordance with the estimator of the position deviation between the reference location and the second acceleration measuring location formed by the computational model. In this case, the deviation of the accelerations between the locations is also taken into account. Therefore, the influence of mechanical vibrations, including the different effects at the two locations, is taken into account. There is no need for a position measurement at the second acceleration measuring location. This is only provided for the reference location on account of the structure of the CMM. Nevertheless, by way of the estimator of the position deviation, the model indirectly supplies the information about the vibration-corrected position value for the second acceleration measuring location.

Therefore, the following, in particular, is provided: A method for repeated determination of a position of a movable part of a coordinate measuring machine, wherein a measuring sensor of the coordinate measuring machine is moved by way of a movement of the movable part, including these repeatedly carried out steps:
measuring a position value of the movable part with a position measuring system of the coordinate measuring machine, the position measuring system measuring the position value in relation to a reference location of the coordinate measuring machine that can move when the movable part moves,
measuring a first acceleration value at a first acceleration measuring location of the coordinate measuring machine with a first acceleration sensor,
measuring a second acceleration value at a second acceleration measuring location of the movable part with a second acceleration sensor, with the second acceleration measuring location being arranged closer to the measuring sensor than the first acceleration measuring location or being a location of the measuring sensor and with the first acceleration measuring location being arranged closer to the reference location than the second acceleration measuring location or being the reference location,
supplying a state value, which describes a target state and/or an actual state of the coordinate measuring machine, to a computational model of the coordinate measuring machine,
forming an estimator of a position deviation between the reference location and the second acceleration measuring location by way of the computational model,
forming and outputting an estimator of an acceleration deviation between the acceleration at the first acceleration measuring location and the acceleration at the second acceleration measuring location by way of the computational model,
supplying a position deviation to the computational model taking into account the estimator of the position deviation between the reference location and the second acceleration measuring location,
supplying an acceleration deviation to the computational model taking into account the estimator of the acceleration deviation between the acceleration at the first acceleration measuring location and the acceleration at the second acceleration measuring location and taking into account a difference between the measured first acceleration value and the measured second acceleration value, and
determining the position of the movable part from the measured position value in relation to the reference location and in accordance with the estimator of the position deviation between the reference location and the second acceleration measuring location formed by the computational model.

Further, the following is provided: An arrangement having a coordinate measuring machine which includes a movable part, the movement of which allows a measuring sensor of the coordinate measuring machine to move, wherein the arrangement further includes:
a position measuring system, the position measuring system being configured to repeatedly measure a position value of the movable part in relation to a reference location of the coordinate measuring machine, the reference location being able to move during a movement of the movable part,
a first acceleration sensor which is configured to repeatedly measure a first acceleration value at a first acceleration measuring location of the coordinate measuring machine,
a second acceleration sensor configured to measure a second acceleration value at a second acceleration measuring location of the movable part, with the second acceleration measuring location being arranged closer to the measuring sensor than the first acceleration measuring location or being a location of the measuring sensor and with the first acceleration measuring location being arranged closer to the reference location than the second acceleration measuring location or being the reference location,
a position determining device in which a computational model of the coordinate measuring machine is implemented and which includes an interface for supplying a state value, which describes a target state and/or an actual state of the coordinate measuring machine, to the computational model, with the position determining device being configured
to repeatedly form an estimator of a position deviation between the reference location and the second acceleration measuring location by way of the computational model,
to repeatedly form an estimator of an acceleration deviation between the acceleration at the first acceleration measuring location and the acceleration at the second acceleration measuring location by way of the computational model,
to repeatedly supply a position deviation to the computational model taking into account the estimator of the position deviation between the reference location and the second acceleration measuring location,
to repeatedly supply an acceleration deviation to the computational model taking into account the estimator of the acceleration deviation between the acceleration at the first acceleration measuring location and the acceleration at the second acceleration measuring location and taking into account a deviation between the measured first acceleration value and the measured second acceleration value,
to repeatedly determine the position of the movable part from the measured position value in relation to the reference location and in accordance with the estimator of the position deviation between the reference location and the second acceleration measuring location formed by the computational model.

In particular, scales which have absolute incremental position values and/or position marks may be part of the position measuring system. By way of example, the scale may be formed on the movable part and/or be connected to the movable part. In this case, the reference location may be, e.g., a marked location on the scale, for example a location at the scale start, at the scale end or in the scale center. By way of example, if the scale is not formed on the movable part on which the reference location is located, the reference location may also be the location of the position sensor which interacts with the scale and determines the position in relation to the scale.

In more general terms and not only related to the aforementioned explicit examples for the pose of the reference location, at least one position sensor of the position measuring system may be arranged on a part of the CMM relative to which the movable part moves. This movable part may be the movable part to which the measuring sensor of the CMM is connected or to which the measuring sensor is coupled. However, the movable part may also be another movable part of the CMM, which is moved together with the movable part to which the measuring sensor is coupled or to which the measuring sensor is connected.

Exemplary embodiments and configurations of the method and the arrangement are described below.

According to one configuration, coordinates of a workpiece measured using the measuring sensor are determined in accordance with the estimator of the position deviation between the reference location and the second acceleration measuring location formed by the computational model and from measurement values and/or signals of the measuring sensor. By way of example, in the case of a switching-type measuring sensor, the signals thereof are used for determining the coordinates. The arrangement may be configured in accordance with the configuration of the method. As a result of the configuration, the determined coordinates are directly improved or coordinate values that have been corrected in respect of the reference location are obtained vis-a-vis the position measurement.

According to a further configuration, each of the position deviation and acceleration deviation supplied to the computational model is supplied with a weighting such that there is a larger influence in the case of a higher set weighting and a lesser influence in the case of a lower set weighting on calculations of the computational model and the weighting is determined on the basis of a quality criterion which takes account of state variables that describe the state of the coordinate measuring machine (such as target values produced by a drive controller or drive regulator, for example), in each case over the course of time during an operating time period. The position determining device of the arrangement can be configured accordingly.

Therefore, the position determining device, in particular, may have an appropriate input interface, with which the weighting can be set. The adjustment may be undertaken automatically if the result of the application of the quality criterion is, for example, determined by the arrangement, the position determining device or the CMM itself and the weighting emerging therefrom is adopted automatically for the computational model.

By setting the weighting, it is possible to improve the computational model and, in particular, optimize the latter on the basis of the quality criterion. By way of example, different coordinate measuring machines have different behaviors in respect of the mechanical vibrations of the movable part. The same coordinate measuring machine may also have a different behavior if, for example, a different measuring sensor is coupled to the movable part. An improvement of the computational model obtained by optimized weighting may, in particular, lead to a better estimation of the course of the position deviation between the reference location and the second acceleration measuring location over time.

In particular, the respective weighting with which the influence of the position deviation or the acceleration deviation is set may consist of a plurality of weighting components. Each of the weighting components may define the influence on one of a plurality of state variables which describe the state of the coordinate measuring machine within the scope of the computational model.

In particular, the quality criterion may supply a result which can be evaluated on the basis of a scale of a scalar variable; in particular, it is possible to determine whether the result lies higher or lower on the scale. In particular, the weightings considered in the quality criterion may be varied until the result of the quality criterion yields a minimum on the scale or, in an alternative exemplary embodiment, a maximum. By way of this minimization or maximization, the associated weightings that yield an optimized computational model are determined.

According to a further configuration (which may also be combined with the above-described configurations), each of the position deviation and acceleration deviation supplied to the computational model is supplied with a weighting such that there is a larger influence in the case of a higher set weighting and a lesser influence in the case of a lower set weighting on calculations of the computational model, wherein the weightings are set such that the influence on the calculations of the computational model resulting from the supplied position deviation is less than the influence from the supplied acceleration deviation. The position determining device of the arrangement can be configured accordingly.

Since the acceleration deviation has a larger influence, the different vibration behavior at the various acceleration measuring locations can be modelled well. The lesser influence of the position deviation allows the time variations in the position deviation that occur at the various acceleration measuring locations in the case of different vibrations. However, independently of its weighting, the feedback of the position deviation ensures, in principle, that the position deviation does not continually increase or continually decrease over time. Such “running away” is a known phenomenon in control engineering and may occur, in particular, when accelerations are used to determine positions.

According to a further configuration (which may also be combined with the above-described configurations), the position deviation supplied to the computational model is equal to the estimator of the position deviation between the reference location and the second acceleration measuring location from a preceding calculation cycle of the computational model or differs from the estimator of the position deviation by a value that is constant over time. The position determining device of the arrangement can be configured accordingly.

Consequently, the fed-back position deviation is not based on a repeatedly measured position deviation corresponding to the different vibration behavior at the reference location and at the second acceleration measuring location. This is based on the assumption that the position deviation over relatively long periods of time is equal to its expected value or long-term temporal mean, which corresponds to reality and particularly effectively prevents the aforementioned “running away” of the position deviation. The constant by which the position deviation supplied to the computational model may differ from the estimator of the position deviation is for example equal to the long-term mean of the difference between the position of the reference location and the position of the second acceleration measuring location. In the case of a constant, the latter typically has the same magnitude every time the estimator of the position deviation is fed back to the computational model.

### BRIEF DESCRIPTION OF THE DRAWINGS

The disclosure will now be described with reference to the drawings wherein:

FIG. 1 shows a gantry-type coordinate measuring machine as an example for a type of coordinate measuring machine that may find use in conjunction with the present disclosure,

FIG. 2 schematically shows a system which may, for example, relate to the coordinate measuring machine depicted in FIG. 1 or a part thereof, with a computational model, for example in the form of an approximated transfer function, being determined from the system,

FIG. 3 schematically shows an exemplary embodiment of a computational model that is based on an observer,

FIG. 4 schematically shows a further exemplary embodiment for a computational model that is based on an observer, with in comparison with FIG. 3 a different state variable as input variable of the computational model,

FIG. 5 schematically shows an additional further exemplary embodiment of a computational model that is based on an observer, with in comparison with FIG. 3 and FIG. 4 a different state variable as input variable of the computational model,

FIG. 6 schematically shows an exemplary embodiment for a computational model that is based on a Kalman filter, and

FIG. 7 schematically shows an exemplary embodiment for a computational model with feedback for the drive regulator in order to damp or compensate mechanical vibrations.

### DESCRIPTION OF EXEMPLARY EMBODIMENTS

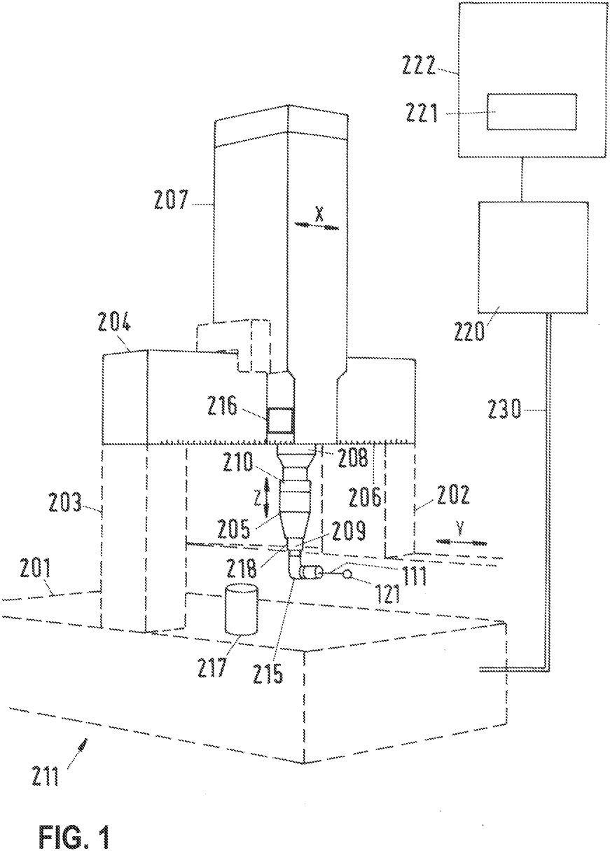

The gantry-type coordinate measuring machine (CMM) 211, shown in FIG. 1, includes a measurement table 201, above which columns 202, 203 are arranged so as to be X-Y-Z movable in the Y-direction of a Cartesian coordinate system. Together with a crossbeam 204, the columns 202, 203 form a gantry of the CMM 211. At its opposite ends, the crossbeam 204 is connected to the columns 202 and 203, respectively. Electric motors (not depicted here) as drives cause the linear movement of the columns 202, 203 and of the parts carried by the columns 202, 203 along the movement axis, which extends in the Y-direction. In this case, an electric motor is assigned for example to only one of the two columns 202, 203 or to each of the two columns 202, 203. The crossbeam 204 is combined with a cross slide 207, which is movable, for example by way of air bearings, along the crossbeam 204 in the X-direction of the Cartesian coordinate system. The current position of the cross slide 207 relative to the crossbeam 204 can be determined on the basis of a scale graduation 206. The movement of the cross slide 207 along the movement axis in the X-direction is driven by at least one further electric motor as a drive (not depicted here). A quill 208, which is movable in the vertical direction, is mounted on the cross slide 207 and connected at the lower end thereof to a measuring head 205 by way of a mounting device 210. An angled, single-axis rotary joint 215 is coupled to the measuring head 205 by way of an interchange interface 209. Using the rotary joint 215, a stylus 111 is connected to a probe sphere 121. Driven by a further electric motor (not illustrated), the rotary joint 215 may be rotated about a rotary axis of the Cartesian coordinate system that extends parallel to the Z-direction such that the stylus is, for example, aligned in the direction of a measurement object 217 that stands on the measurement table 201.

A scale of the position measuring system is represented by a plurality of short lines that extend in the vertical direction at the lower end of the crossbeam 204 in FIG. 1. Further scales may extend, in particular, in the vertical direction (Z-direction) along the quill 208 and in the horizontal direction along the longitudinal edges of the measurement table 201 (in the Y-direction). Using assigned position measuring sensors, which are each arranged on a part of the CMM 211 and relative to which the scale moves, the position measuring system measures the position of the quill 208 (directly with involvement of the quill or indirectly without involvement of the quill), in particular in the Y-direction, X-direction and Z-direction. Which of these measurement values are corrected on the basis of the calculations of a computational model depends on the directions for which mechanical vibrations are detected by appropriate acceleration sensors.

Further, FIG. 1 shows an evaluation device 220 which receives the measurement signals from the measuring head by way of a schematically depicted connection 230. A schematically depicted controller 222 of the CMM 211 actuates the drives (e.g., the aforementioned electric motors). In particular, by controlling the drives, the controller 222 can displace the stylus 111 into a desired position and align the stylus 111 in a desired measuring direction.

The controller 222 is further combined with a computing device 221, or includes the latter, in which the calculations of the computational model are executed repeatedly during the operation of the CMM 211. The computing device 221 can be part of the CMM 211 or be embodied separately as a further part of an arrangement with the CMM 211.

At least one first acceleration sensor 216 and one second acceleration sensor 218 are arranged on the CMM 211 in the exemplary embodiment. The first acceleration sensor 216 is integrated in the cross slide 207 and measures at least the acceleration component in the X-direction. The second acceleration sensor 218 is integrated in the quill-side part of the interchange interface 209, for example. Alternatively, the second acceleration sensor may be integrated in, e.g., the upper part of the mounting device 210 which, in FIG. 1, is drawn as a narrower cylindrical part.

The second acceleration sensor 218 likewise measures at least the acceleration component in the X-direction. If at least one further acceleration sensor (not depicted here) is provided and serves to measure the acceleration component of the gantry (e.g., at the column 202) in the Y-direction, then, typically, the second acceleration sensor 218 or a further acceleration sensor in the lower end region of the quill 208 is configured to likewise measure the Y-component of the acceleration. The computational model typically calculates the estimators for the position deviations of the X-component and the Y-component separately. In particular, the computational model may have two separate model parts, which are each supplied with the aforementioned deviations and state values.

The computational model repeatedly forms (e.g., during each work cycle) estimators of a position deviation between a reference location (in particular at a scale for determining the X-position or the Y-position) and the second acceleration measuring location. As mentioned, FIG. 1 shows a scale with a scale graduation 206 for determining the X-position, and hence indirectly also the X-position of the quill 208 relative to the crossbeam 204.

In particular, the results of the computational model are used to determine the coordinates of the workpiece 217 to be measured in the coordinate system of the CMM 211 from the measurement values of the measuring head 205, or to correct said determined coordinates.

The estimators of the computational model are repeatedly formed, especially in each work cycle of the drive controller or drive regulator, and control signals for actuating the drives of the CMM 211 are produced taking account of the estimator for the position deviation. Therefore, it is possible to damp or compensate mechanical vibrations at the predetermined location using these control signals. In particular, this procedure is not restricted to the CMM 211 depicted in FIG. 1, but can be carried out for any type of CMM with a drive controller or drive regulator.

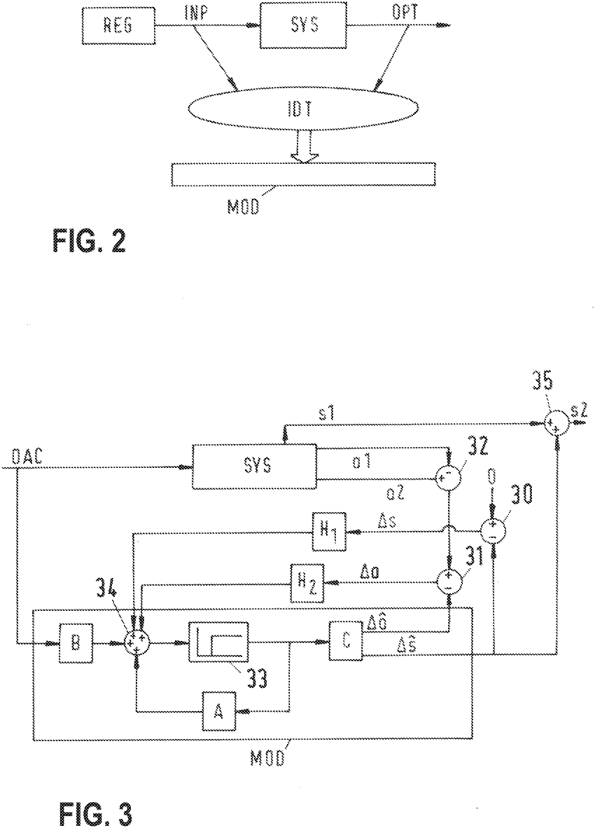

Explanations are now provided with reference to FIG. 2 in relation to how a model, e.g., in the form of an approximated transfer function, may be determined for a system SYS, for example the coordinate measuring machine 211 depicted in FIG. 1.

A separately depicted regulator REG, which actuates at least one drive of the system SYS, outputs control signals which are supplied to another part of the regulator REG or directly to at least one drive of the system SYS. These output signals are input signals INP for the system SYS. The system SYS in turn outputs output signals OPT. In relation to the present disclosure, the input signals INP are the target values of the drive controller or drive regulator, which are supplied to the computational model. The output signals OPT are at least the position measurement values and/or the acceleration measurement values.

In a method step IDT of identifying the system SYS, the input signals INP and the output signals OPT are processed to form a model MOD of the system SYS. Optionally, additional information may be used for the model MOD in addition to the input signals INP and the output signals OPT, e.g., information about physical properties of the system SYS.

Unlike what is depicted in FIG. 2, the system SYS, which should be described by the model MOD, might not receive the output signal of the regulator REG as input signal INP but the signal of a different input variable. As mentioned above, the input variable may relate to a different target state and/or an actual state of the coordinate measuring machine.

The computational model that is used for determining the position of the movable part of a coordinate measuring machine with position estimators may be, in particular, the model MOD from FIG. 2. However, the disclosure is not restricted thereto. There may be different types of models.

The computational model may use state variables of the system in its calculations and values of a plurality of state variables of the system may optionally also be repeatedly supplied thereto, particularly if, like, e.g., in the case of the computational model MOD from FIG. 2, input signals INP and output signals OPT are used for defining the model. The state variables may be physical state variables such as the position of the movable part at the reference location or at the second acceleration measuring location, the corresponding speed of the movable part and the corresponding acceleration of the movable part. However, alternatively or additionally, these may be purely mathematical state variables without a defined physical meaning. In particular, the totality of the state variables may be described by a state vector, the components of which are the individual state variables. Such a state vector can be processed by the computational model in a manner which can be described by multiplication of the state vector by an operation matrix.

Therefore, phrased in general terms, the computational model may be a purely mathematical model or a mathematical model with at least partial physical meaning. The computational model may also be a purely physical model, in which the behavior of the system in respect of mechanical vibrations is described, for example by appropriate differential equations which, for example, describe spring-mass interactions in accordance with the system. In this case, the implemented form of the computational model contains solutions or approximate solutions of the differential equations.

A finite element model (FEM), which uses the masses of the CMM, the damping properties thereof for damping mechanical vibrations and the rigidity properties of the CMM for computational modelling of the CMM, is another form of the physical modelling of a coordinate measuring machine. Such FEMs have already been described in the field of coordinate metrology and are not explained in any more detail here. The FEM implemented in the computational model may, e.g., as a computer program, output matrices and/or vectors which, taking into account the acting excitation forces that lead to mechanical vibrations, describe the system behavior. A state space model that is suitable for the purposes of the disclosure may be produced in this way.

The vibration behavior of a CMM, in particular at the locations for the acceleration measurement and estimation by the computational model, may depend on the movement state of the CMM. By way of example, the vibration behavior in the case of a maximally extended horizontal arm may be different to where the horizontal arm is extended less far. In the case of a gantry-type CMM, the vibration behavior generally also depends on the movement position in respect of each of the three linear axes X, Y, and Z. In particular, the position in the X-direction of the slide (reference sign 207 in FIG. 1) that can move along the crossbeam (reference sign 204 in FIG. 1) is important for the vibration behavior at the lower end of the quill (reference sign 208 in FIG. 1). A corresponding statement applies to the Z-position of the quill, which is also important for the vibration behavior.

The spatial dependence of the vibration behavior can be taken into account in different ways. By way of example, the model may take account of the dependence of the vibration behavior of the system on the position of the movable part for example by parameters of the model which have different values depending on the position of the movable part. Such a model may consist of partial differential equations. Alternatively, a respective computational model can be generated for different movement states of the CMM and, in particular, for different movement positions of the measuring sensor. Which computational model is then used during the operation of the CMM depends on the movement state. By way of example, a respective computational model can be produced for a discrete number of movement positions (raster-type positions) of the measuring sensor or of the movable part on which the measuring sensor is arranged, and the computational model produced for the raster-type position closest to the current position is used during the operation of the CMM. Further alternatively, the model can be configured to be so robust that it only depends on the movement state of the CMM to a small extent. The aforementioned repeated feedback of the position deviation and acceleration deviation to the computational model enables the robust configuration of the latter, in particular. A different vibration behavior, e.g., a different vibration frequency or different vibration amplitude, is detected by the measurement signals of the acceleration sensors and is therefore available to the model as a result of feeding back the acceleration deviation. Feeding back the position deviation stabilizes the computational model in relation to the aforementioned “running away” of the position.

The state values (input signals INP in the example of FIG. 2) can be values of an analogue variable or digital values. By way of example, this depends on whether the drive controller or the drive regulator produces and outputs analogue or digital values. In the case of digital values, the conversion of analogue values into digital values for a digital computational model is dispensed with.

The further description resorts to the exemplary embodiment of a computational model a number of times, in which computational model, as mentioned above, a plurality of state variables describe the respective system state. In particular, the state variables are processed as components of the state vector in what is known as a state space model in order to produce and output the aforementioned estimators.

As will still be explained in more detail, the computational model can be implemented based on the principle of an observer or a Kalman filter. The computational operations of the computational model are repeatedly carried out, in particular with the system clock of the controller of the CMM, in particular a real-time controller. In particular, a set of input values (acceleration deviation and position deviation, in each case optionally weighted or processed, state value) is received in each work cycle and an estimator of the acceleration deviation is formed and output. An estimator of the position deviation is typically also output. The position in the work cycle of the computational model at which the processed values for the acceleration deviation and the position deviation are supplied depends on the embodiment either as an observer or as a Kalman filter.

It is typical that the weighting of the acceleration deviation and position deviation that are fed back into the computational model is set in such a way that the temporal profile of the estimated position deviation, as determined by the computational model, follows the vibration profile emerging from the acceleration measurement values over a few (e.g., three or five) vibration cycles, with, however, a phase offset possibly occurring between the time profile of the deviation of the acceleration measurement values and the estimated acceleration deviation on account of the phase measurement error of the acceleration sensors.

An exemplary embodiment for a computational model that is based on an observer is initially described below with reference to FIG. 3. Like in FIG. 2, the system is also presented schematically in FIG. 3 by a rectangular frame that is denoted by SYS. Target values DAC of the drive controller or drive regulator are supplied both to the system SYS and the computational model MOD. The supply and processing of values is effectuated, in particular, in the system work cycle of the CMM. Output variables of the system are the position s1 of the reference location, which are created in the form of position measurement values of the position measuring system of the CMM, the first acceleration a1 at a first acceleration measuring location (e.g., at the reference location) and the second acceleration a2 at a second acceleration measuring location, which are available in the form of acceleration measurement values of the first and of the second acceleration sensor. Estimators, specifically the estimator Δa̅ of the acceleration deviation and the estimator Δs̅ of the position deviation are output by the computational model MOD.

FIG. 3 symbolically depicts a first determination device 30, which is supplied with the estimator Δs̅ of the position deviation. It is further depicted that the determination device 30 is also supplied with the value 0. However, this merely indicates that the estimator Δs̅ of the position deviation is returned without a change to the computational model MOD as a position deviation Δs, with processing that will be discussed below additionally occurring. Therefore, the first determination device 30 can be dispensed with.

The acceleration deviation Δa is determined by a second determination device 30, in each case from the current deviation of the first acceleration a1 from the second acceleration a2, which is formed by a third determination device 32, and from the current estimator Δa̅ of the acceleration deviation, with, expressed more completely, the acceleration deviation Δa being the deviation of an acceleration deviation which is fed back to the computational model MOD in yet again processed form.

Here, the position deviation Δs is multiplied by a weighting operator H1 (e.g., a scalar, a vector or a matrix). In the case of a vector or a matrix, the components of this first weighting operator H1 are weighting components in respect of, in each case, a state variable of a state vector or state space, which describes the state of the system SYS. In particular, the weighting components can be temporally constant weighting components, i.e., they do not change over time. The state variables can be physical state variables or mathematical state variables. By way of example, the computational model MOD can use the physical state variables of position at the first and second acceleration measuring location, and optionally also the speed at at least one of these locations and the position at these locations. In this case, for example, it is possible to determine time derivatives of the position and/or integrations of the acceleration with respect to time, and optionally of the speed. The same as for the first weighting operator H1 correspondingly also applies to a second weighting operator H2, with which the acceleration deviation Δa is weighted and with which, for example by way of different weighting components, it is possible to undertake weightings in relation to the various state variables. Weighting components of the first weighting operator H1 and of the second weighting operator H2 may have the value zero, i.e., no influence of the respective deviation is exerted in respect of individual state variables.

Optionally, three, four or five purely mathematical state variables, for example, may be added in the exemplary embodiment in addition to the physical state variables in order to be able to better describe the behavior of the system SYS. Alternatively, all state variables of the model can be purely mathematical state variables.

The deviations Δs and Δa weighted thus are supplied to the computational model MOD via a combination device 34. Moreover, the target value DAC of the drive controller or drive regulator is supplied to the combination device 34, weighted by multiplication with a weighting operator B (e.g., a scalar, vector or a matrix) in the exemplary embodiment. In particular, the weighting operator B corresponds to the control vector of the state space model. Optionally, like the weighting operators H as well, the weighting operator B may have a plurality of weighting components which set the influence of the respectively currently valid target value to various state variables of the model. If the weighting operator B is a scalar, no influences on various state variables are caused at this point of the model.

Reference sign 33 denotes a retardation member. Such a retardation member is known from control engineering for representing controls and symbolically represents the behavior corresponding to the clocked processing of the data. In the case of FIG. 3, this means that the input values of the computational model MOD, which are produced from the target values DAC, the position deviation Δs and the acceleration deviation Δa, are only of importance in the next work cycle. This follows from the actual computational operation of the model being represented by the matrix A at the bottom of FIG. 3 and the result of the computational operations of the model in each work cycle likewise being supplied to the combination device 34. Accordingly, these actual computational operations use the values supplied to the model from the preceding work cycle. Further, as represented by an operation with the matrix C (alternatively a vector), in each work cycle the result of the calculation after the combination is output by the combination device 34 with a delay of one work cycle. As mentioned previously, the estimator Δs̅ of the position deviation and the estimator Δa̅ of the acceleration deviation are output from the computational model. The current estimator Δs̅ of the position deviation is added to the current value of the position s1 of the reference location with a fourth processing device 35, as a result of which the estimated or corrected position s2 at the second acceleration measuring location emerges.

In the case of the above-described variant according to which the estimator Δs̅ of the position deviation may receive a value of the position difference or of the spacing of the two acceleration measuring locations that is constant in time, it is not only the time-varying estimator Δs̅ of the position deviation with the temporal mean of zero that is added, but also the constant.

Since the parameters of the feedback coefficients, which define the vectors, scalars or matrices H1 and H2, in particular may be a large number of parameters (e.g., a total of five to thirty), it is typical for the parameter values to be determined in advance, i.e., before the operation of the coordinate measuring machine, using a quality criterion. In particular, a test operation of the coordinate measuring machine may occur to this end. In the following equation:

$$J = {J}_{0} + {\int }_{0}^{∞} {x}^{′} Q x d t + {\int }_{0}^{∞} {u}^{′} R u d t = M i n$$

J denotes the result of the calculation within the scope of the quality criterion, Jo denotes a predeterminable fixed value (which may be selected to be zero in many exemplary embodiments), x denotes the state vector which is formed from the values of the state variables as components of the vector and which is determinable by the matrices, vectors or scalars A and C of the state space model, x′ denotes the corresponding transposed state vector in order to form a scalar variable from the state vector by matrix multiplication, Q denotes a matrix which allows adjustment of the degree with which trust is placed on the measurement values or, in contrast thereto, on the model, as a result of which it is possible to set the dynamics, in accordance with which the influences of the measurement values decay, u denotes a vector:

$$u = - H x ,$$

which is formed from the respective target value DAC and moreover contains the parameters of the sought-after matrix, the sought-after vector or the sought-after scalar H (consisting of, e.g., the two columns formed by the vectors H₁ and H₂ in the case of a matrix) as coefficients in particular, u′denotes the corresponding transposed vector in order to obtain a scalar variable by multiplication with the matrix R, which renders it possible to set the speed with which the influences on the measurement values decay. By way of example, the program Matlab can be used to implement the computational model and/or calculate the parameters.

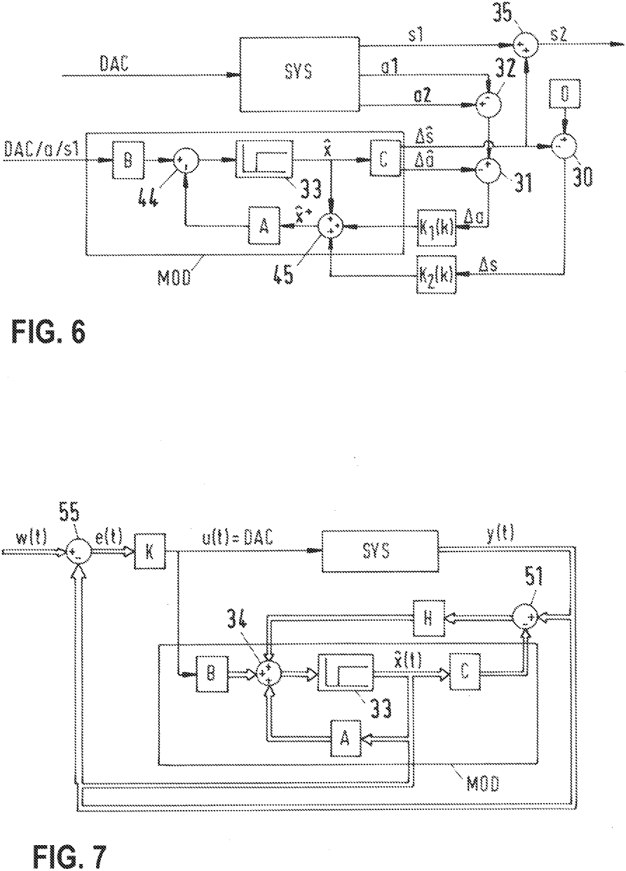

In the further part of the description, FIG. 6 is used to describe another computational model that is based on a Kalman filter. A quality criterion that is similar to what is described by the above equations may be used for setting the parameters of the Kalman filter or of the model in accordance with FIG. 6. However, the matrix R in this case has a deviating meaning from the case of the model based on the observer. In the case of the Kalman filter, values of the matrix R are used to set the degree with which the measurement values are afflicted by noise, i.e., have random or quasi-random variations which, for example, are produced by analogue sensors (acceleration sensor and sensors of the position measuring system).

The expression Min in the equation above expresses that the result J of the calculation of the quality criterion is minimized by varying the parameters contained in the matrix, the vector or the scalar H. When the minimum or a minimum has been found, the corresponding set of parameter values is adopted in the computational model and used during the operation of the coordinate measuring machine.

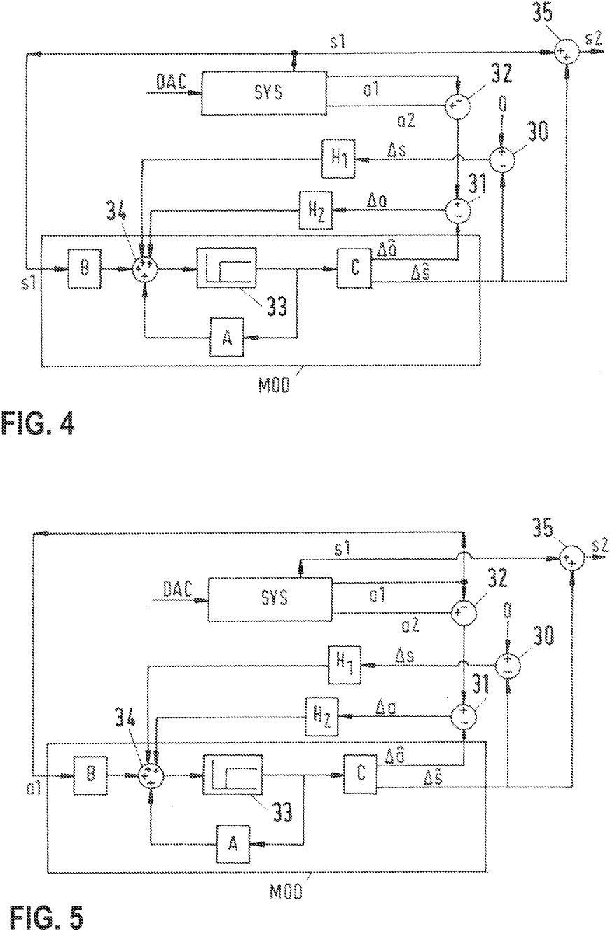

FIG. 4 shows a variant of the observer-based determination of the position at the second acceleration measuring location. Only the differences to the configuration of FIG. 3 are described below. The model MOD according to FIG. 4 is only a partial model of the controlled system, which is supplied with the respective current position measurement value s1 (i.e., an actual value of the state) for the reference location. The model consequently does not model the drive of the system. This simplifies the model and, in particular, operators A, B, C are simplified, i.e., contain fewer parameters.

In the variant, depicted in FIG. 5, of the observer-based determination of the position at the second acceleration measuring location, the model MOD is also a partial model of the controlled system. In this variant, the model MOD is supplied with the current value of the acceleration a2 at the second acceleration measuring location as actual value of the state of the system SYS. In a further variant not depicted in the figures, the model MOD could instead be supplied with the current value of the acceleration a1 at the first acceleration measuring location as actual value of the state of the system SYS. Further variants are conceivable. In particular, a speed at one of the acceleration measuring locations comes into question as actual value of the state of the system SYS supplied to the model MOD, with the speed possibly being obtained by integrating one of the acceleration measurement values over time or, in the case where the position of the reference location is measured, possibly being obtained by differentiation with respect to time. Further, there are variants in which in each case a different target value of the drive controller or drive regulator of the system SYS to the control current of one or more drive motors is supplied to the model MOD as target value of the state of the system.

FIG. 6 shows an illustration corresponding to FIG. 3, in which, however, the computational model MOD is based on a Kalman filter. The same symbols are used in respect of the measurement variables and estimated variables, and also in view of the target values and actual values. The determination devices 30, 31, and 32 also have the same function and meaning as in the case of FIG. 3 and are denoted by the same reference signs as in FIG. 3. However, the combination device at the input of the retardation member 33 in FIG. 4 is denoted by reference sign 44 since it only combines the results of the actual model calculation (once again symbolized by the matrix A) and the target value DAC that has been weighted by the operator B. As an alternative to the target value DAC, the actual value of the current position measurement value s1 or the actual value of one of the current acceleration measurement values a can be supplied to the model MOD as state value of the CMM, in a manner corresponding to FIG. 4 and FIG. 5.

In contrast to FIG. 3, a further combination device 45 still is present, said combination device combining the state vector x̂ at the end of the work cycle with the weighted position deviation Δs and the weighted acceleration deviation Δa. A modified state vector x̂+ arises as output variable of the second combination device 45. In accordance with the principle of the Kalman filter, the weighting is effectuated by operators that are not constant in time, e.g., vectors which in FIG. 6 are denoted by the symbol K₁(k) in relation to the weighting of the acceleration deviation Δa and by the symbol K₂(k) in relation to the weighting of the position deviation Δs. Once again, this may relate to a vector which has weighting components which set the influence of the respective deviation on an assigned state variable. The weighted deviations are therefore supplied at the start of the work cycle and the resultant modified state vector x̂⁺ is used for carrying out the model calculations within the work cycle, as depicted in FIG. 6. This modified state vector is available at the input of the operator A (e.g., a matrix).

The calculation of the parameters of the computational model MOD is effectuated, e.g., using the following equations which lead to a modification or correction of the state variables in the current cycle. In principle, the Kalman filter reacts more quickly to the deviations that are fed back than the observers in accordance with FIG. 3 to FIG. 5:

$${P}_{n} = A {P}_{n - 1}^{+} {A}^{′} + Q$$

$${K}_{n} = {P}_{n} {C}^{′} {\left(C {P}_{n} C ′ + R\right)}^{- 1}$$

$${P}_{n}^{+} = \left(E - {K}_{n} C\right) {P}_{n}$$

$${\hat{x}}_{n} = A {\hat{x}}_{n - 1} + B {u}_{n}$$

$${\hat{y}}_{n} = C {\hat{x}}_{n - 1}$$

$${\hat{x}}_{n}^{+} = {\hat{x}}_{n} + {K}_{n} \left({y}_{m e s s} - {\hat{y}}_{n}\right)$$

Here, Pₙ denotes the result of the operation in the respective work cycle n, which is represented on the right-hand side of the first line of the set of equations, and corresponds to the covariance matrix which reproduces the uncertainty of the estimate, A denotes the matrix A from FIG. 4, which may be referred to as the system matrix,

$${P}_{n - 1}^{+}$$

denotes the covariance matrix from the preceding work cycle or, in the first work cycle, a given matrix (which defines the start values of the state variables, where a value of zero can be placed in the case of each unknown start value if applicable), Q denotes the matrix which defines the dynamics of the computational model in a manner analogous to the quality criterion of the observer, A′ denotes the transposed system matrix A, Kₙdenotes the result of the operation on the right-hand side of the second equation of the set of equations, which is referred to as Kalman gain, C denotes the model matrix from FIG. 4 which applied to the state vector x̂ produces the estimators for position and acceleration, C′ denotes the transposed model matrix C, R denotes a matrix describing the noise in the measurement values,

$${P}_{n}^{+}$$

denotes the updated covariance matrix in the current cycle, E denotes an identity matrix, i.e., a matrix where a value of 1 is located all along the main diagonal and the remaining values are zero,

$${\hat{x}}_{n - 1}$$

denotes the state vector from the preceding work cycle, for which initial values of the state variables are defined for the first work cycle, B denotes the operator represented in FIG. 4, uₙ denotes the vector formed by the current target values DAC of the drive controller or drive regulator and which may be a scalar, or, for example, only one component of the vector is not equal to zero, , ŷₙ denotes the result of the operation in the fifth equation of the set of equations represented above,

$${\hat{x}}_{n}^{+}$$

denotes the result of the operation on the right-hand side of the sixth and last equation of the aforementioned set of equations and yₘₑₛₛ denotes a vector whose components are formed by the measurement values of the position s for the reference location and by the measurement values of the accelerations a. Here, the matrix Kₙ is a matrix from which both the operator K₁(k) and the operator K₂(k) are formed or both said operators consist of said matrix. By way of example, the two operators are matrices which are composed to the larger matrix Kₙ consisting of more lines and columns.

As a result of the described type of cycle-dependent feedback of the position deviation values and the acceleration deviation values in the Kalman filter, a computational model that reacts more quickly than the observer is obtained, said computational model consequently also being more robust in relation to the position dependence of the vibration behaviour of the movable part of the CMM. Using the model that is based on the Kalman filter, it is also possible to better compensate inaccuracies when creating the computational model; i.e., the behaviour of the system is modelled better despite the inaccuracies of the computational model.

In addition to the mechanical vibrations of the movable part, which are caused by the drives of the CMM, there may also be vibrations on account of different causes, said vibrations also relating to the base (e.g., a granite slab) of the CMM, as already mentioned above. If the base vibrates as well, this may have direct effects on the measurement results of the acceleration sensor at the first acceleration measuring location (close to the reference location). However, since the acceleration is additionally also measured at the second acceleration measuring location close to the measuring sensor and the difference of the acceleration values is processed further, the method is robust vis-a-vis vibrations of the base of the CMM. All vibrations produced in the same way at the acceleration measuring locations as a result of vibrations of the base are cancelled as a result of subtraction.

Nevertheless, an additional acceleration sensor for measuring the vibrations of the base may optionally be used. In this case, it is moreover possible to repeatedly form the difference between the measurement values at the first or second acceleration measuring location and the measurement value of the base, and the effects of the mechanical vibrations of the base can be eliminated thereby.

Now, an exemplary embodiment for taking into account the position s2 at the second acceleration measuring location for the drives of the CMM, as estimated with the aid of the computational model, is described on the basis of FIG. 7. In particular, this may be used for damping the vibrations that are caused by the drives. However, particularly in the case of the Kalman filter, it is even possible to obtain a comprehensive compensation of the mechanical vibrations, i.e., the control signals of the drive controller or drive regulator that are produced taking into account the estimated position s2 lead to a significantly reduced vibration amplitude already at the start of a mechanical vibration of the movable part that is excited by the drives when compared to the case in which the position that is estimated by the computational model is not taken into account for actuating the drives or the at least one drive.

FIG. 7 contains a similar illustration to the case of FIG. 3, i.e., the computational model is based on an observer. Alternatively, use could be made of a computational model that is based on a Kalman filter. However, the illustration in FIG. 7 is simplified in respect of the operators H, which produce appropriately weighted influencing variables for the computational model MOD from the position deviation and the acceleration deviations. These operators are denoted by the symbol H in FIG. 7 in a combined manner. The two determination devices 31, 32 from FIG. 3 are depicted in a combined manner in FIG. 7 by a single determination device 51. However, the function of these determination devices and of the operators H does not differ from the case in FIG. 3.

Further, the measured position s1 and the accelerations a1 and a2 at the output of the system SYS are represented in FIG. 7 by a vector y(t) that is dependent on time t. Both the current values of the vector y and the current estimated state vector x̂(t) that is produced by the computational model MOD are supplied to a combination device 55, the latter also being supplied with a time-dependent reference variable w(t). Here, the state vector, which is output by the computational model MOD, may also contain further state variables, e.g., purely mathematical and/or further physical state variables and/or the speed of the movable part, in addition to the physical state variables of position deviation Δŝ and the acceleration deviation Δâ. From the aforementioned supplied values, the combination device 55 produces a regulating error e(t) as an output variable, to which an operator K (e.g., a vector) is applied. A weighting can be undertaken by way of the operator K. The target value variable u(t) emerges therefrom, said target value variable possibly being the same target value variable as in the cases of FIG. 3 and FIG. 6. This is indicated by the additional use of the label DAC. Like in the above-described cases as well, this may relate here to, e.g., the target rotational speed, the target speed, the target current or the control voltage of at least one drive of the CMM. Alternatively, like in the cases of FIG. 4 and FIG. 5 and the aforementioned variants relating to the Kalman filter in FIG. 6, this may relate to the aforementioned actual value variable. In this case, a representation that has been modified vis-a-vis FIG. 7 applies, within the scope of which the target value variable DAC is supplied to the system SYS but not supplied to the model MOD, the latter then receiving the actual value, in particular directly from the output of the system SYS, as depicted in FIG. 4 and FIG. 5.

Alternatively, feeding back the measurement vector y(t) or a corresponding scalar, the latter in the case of only one feedback measurement variable, and the estimated state vector x̂(t) can be carried out in such a way that, for each state variable, only one of the two feedback vectors or scalars contains a value unequal to 0. As a result of this, there is a clear definition as to which of the two feedback vectors or scalars has an influence on the drive regulator in respect of this state variable. However, nor is it necessary for a value to be fed back to the combination device 55 for all state variables that are taken into account by the computational model MOD. What set of feedback state variables achieves the best damping or compensation of vibrations can be determined within a test operation or simulation, in particular by varying the set of state variables that are fed back to the combination device 55.

What can be achieved, in particular, on account of the function of the combination device 55 is that each defined state variable that is to be fed back (e.g., the acceleration and the position) is contained only as a single state variable in the regulating error e(t) despite the feedback of both the measurement vector y(t) and the estimated state vector x̂(t). Here, the vector or scalar w(t) only has the dimension of the number of defined feedback state variables. What can be achieved by filling the reference variable w(t) with a zero in the component corresponding to a state variable, particularly if the combination device 55 forms the difference between the reference variable w(t) and the feedback vector, to be precise component-by-component for each state variable, is that the negative value of the corresponding state variable is directly assigned to a corresponding element of the regulating error e(t), i.e., a difference is formed, in which the corresponding component of the vector w(t) has a value of zero. Here, it is also possible for a component of the vector of the reference variable w(t) to permanently have a value of zero.

The parameters of the model are defined by the respective above-described method of model formation. The values of the operator K may be determined in advance on the basis of a quality criterion, in a manner analogous to what is described above in the case of the observer. Here, it is optionally possible to proceed in two steps. Initially, the observer or the Kalman filter can be designed as described above and the corresponding parameters H can be determined. Then, the parameters of the operator K can be determined in a second step by renewed application of a quality criterion. Like in the case of the quality criterion, the application of which was described in conjunction with FIG. 3, it is also possible for a plurality of elements, or even the vast majority of elements, of the matrices R and Q to be occupied with a value of 0. This simplifies the application of the quality criterion. By way of example, it is possible to determine the occupancy of the matrices Q and R which leads to the best result using matrices which are differently occupied with the zero values in various applications of the quality criterion. A further option for arriving quickly and reliably at suitable parameter values for the operators in FIG. 7 lies in the already mentioned non-consideration of at least one state variable within the scope of the feedback, i.e., this state variable or these state variables are not fed back to the combination device 55.

It is understood that the foregoing description is that of the exemplary embodiments of the disclosure and that various changes and modifications may be made thereto without departing from the spirit and scope of the disclosure as defined in the appended claims.

What is claimed is:

1. A method for repeated determination of a position of a movable part of a coordinate measuring machine, wherein a measuring sensor of the coordinate measuring machine is moved by a movement of the movable part, the method comprising:
(a) measuring a position value of the movable part with a position measuring system of the coordinate measuring machine, the position measuring system measuring the position value in relation to a reference location of the coordinate measuring machine that can move when the movable part moves;
(b) measuring a first acceleration value at a first acceleration measuring location of the coordinate measuring machine with a first acceleration sensor;
(c) measuring a second acceleration value at a second acceleration measuring location of the movable part with a second acceleration sensor, the second acceleration measuring location being arranged closer to the measuring sensor than the first acceleration measuring location or being a location of the measuring sensor, and the first acceleration measuring location being arranged closer to the reference location than the second acceleration measuring location or being the reference location;
(d) supplying a state value, which describes at least one of a target state and an actual state of the coordinate measuring machine, to a computational model of the coordinate measuring machine;
(e) forming an estimator of a position deviation between the reference location and the second acceleration measuring location with the computational model;
(f) forming and outputting an estimator of an acceleration deviation between an acceleration at the first acceleration measuring location and the acceleration at the second acceleration measuring location with the computational model;
(g) supplying the position deviation to the computational model taking into account the estimator of the position deviation between the reference location and the second acceleration measuring location;
(h) supplying the acceleration deviation to the computational model taking into account the estimator of the acceleration deviation between the acceleration at the first acceleration measuring location and the acceleration at the second acceleration measuring location and taking into account a deviation between the measured first acceleration value and the measured second acceleration value;
(i) determining the position of the movable part from the measured position value in relation to the reference location and in accordance with the estimator of the position deviation between the reference location and the second acceleration measuring location formed by the computational model, and
wherein steps (a) to (i) are repeatedly carried out.

2. The method according to claim 1, wherein coordinates of a workpiece measured with the measuring sensor are determined in accordance with the estimator of the position deviation between the reference location and the second acceleration measuring location formed by the computational model and from at least one of measurement values and signals of the measuring sensor.

3. The method according to claim 1, wherein the position deviation and the acceleration deviation supplied to the computational model are each supplied with a weighting such that there is a larger influence in the case of a higher set weighting and a lesser influence in the case of a lower set weighting on calculations of the computational model, and
wherein the weighting is determined based on a quality criterion which takes account of state variables that describe the state of the coordinate measuring machine, in each case over a course of time during an operating time period.

4. The method according to claim 1, wherein the position deviation and the acceleration deviation supplied to the computational model are each supplied with a weighting such that there is a larger influence in the case of a higher set weighting and a lesser influence in the case of a lower set weighting on calculations of the computational model, and
wherein weightings are set such that an influence on a calculation of the computational model resulting from the supplied position deviation is less than the influence from the supplied acceleration deviation.

5. The method according to claim 1, wherein the position deviation supplied to the computational model is equal to the estimator of the position deviation between the reference location and the second acceleration measuring location from a preceding calculation cycle of the computational model or differs from the estimator of the position deviation by a value that is constant over time.

6. An arrangement having a coordinate measuring machine which includes a movable part, a movement of which allows a measuring sensor of the coordinate measuring machine to move, the arrangement comprising:
a position measuring system, the position measuring system being configured to repeatedly measure a position value of the movable part in relation to a reference location of the coordinate measuring machine, the reference location being able to move during the movement of the movable part;
a first acceleration sensor configured to repeatedly measure a first acceleration value at a first acceleration measuring location of the coordinate measuring machine;
a second acceleration sensor configured to repeatedly measure a second acceleration value at a second acceleration measuring location of the movable part, the second acceleration measuring location being arranged closer to the measuring sensor than the first acceleration measuring location or being a location of the measuring sensor and the first acceleration measuring location being arranged closer to the reference location than the second acceleration measuring location or being the reference location;
a position determining device in which a computational model of the coordinate measuring machine is implemented and which comprises an interface for supplying a state value, which describes at least one of a target state and an actual state of the coordinate measuring machine, to the computational model;
wherein the position determining device is configured to:
repeatedly form an estimator of a position deviation between the reference location and the second acceleration measuring location with the computational model,
repeatedly form an estimator of an acceleration in a deviation between the acceleration at the first acceleration measuring location and the acceleration at the second acceleration measuring location with the computational model,
repeatedly supply the position deviation to the computational model taking into account the estimator of the position deviation between the reference location and the second acceleration measuring location,
repeatedly supply an acceleration deviation to the computational model taking into account the estimator of the acceleration deviation between the acceleration at the first acceleration measuring location and the acceleration at the second acceleration measuring location and taking into account the deviation between the measured first acceleration value and the measured second acceleration value, and
repeatedly determine a position of the movable part from the measured position value in relation to the reference location and in accordance with the estimator of the position deviation between the reference location and the second acceleration measuring location formed by the computational model.

7. The arrangement according to claim 6, wherein the arrangement is configured to determine coordinates of a workpiece measured with the measuring sensor, in accordance with the estimator of the position deviation between the reference location and the second acceleration measuring location formed by the computational model and from at least one of measurement values and signals of the measuring sensor.

8. The arrangement according to claim 6, wherein the position determining device is configured to supply each of the position deviation and the acceleration deviation supplied to the computational model with a weighting such that there is a larger influence in the case of a higher set weighting and a lesser influence in the case of a lower set weighting on calculations of the computational model, and
wherein the weighting is determined based on a quality criterion which takes account of state variables that describe the state of the coordinate measuring machine, in each case over a course of time during an operating time period.

9. The arrangement according to claim 6, wherein the position determining device is configured to supply each of the position deviation and the acceleration deviation supplied to the computational model with a weighting such that there is a larger influence in the case of a higher set weighting and a lesser influence in the case of a lower set weighting (H) on calculations of the computational model, and
wherein weightings are set such that an influence on the calculations of the computational model resulting from the supplied position deviation is less than the influence from the supplied acceleration deviation.

10. The arrangement according to claim 6, wherein the position determining device is configured such that the position deviation supplied to the computational model is equal to the estimator of the position deviation between the reference location and the second acceleration measuring location from a preceding calculation cycle of the computational model or differs from the estimator of the position deviation by a value that is constant over time.
